(19) United States
(12) Patent Application Publication
(10) Pub. No.: US 2016/0265364 A1
(43) Pub. Date: Sep. 15, 2016

(54) TURBINE BLADE

(71) Applicant: SIENENS AKTIENGESELLSCHAFT, München (DE)

(72) Inventors: Fathi Ahmad, Kaarst (DE); Christian Menke, Essen (DE); Radan Radulovic, Bochum (DE)

(73) Assignee: Siemens Aktiengesellschaft, Munich (DE)

(21) Appl. No.: 15/030,058

(22) PCT Filed: Sep. 22, 2014
(86) PCT No.: PCT/EP2014/070107

§ 371 Date: Apr. 16, 2016

(30) Foreign Application Priority Data
Oct. 21, 2013 (EP) 13189518.7

(51) Int. Cl. F01D 5/18; F01D 9/02; F01D 25/12; F01D 5/30

(52) U.S. Cl. CPC F01D 5/18; F01D 5/3007; F01D 9/02; F01D 25/12; F05D 2220/32; F05D 2260/232; F05D 2240/81; F05D 2260/22141

(57) ABSTRACT

A turbine blade for a gas turbine has a securing region and a platform region that adjoins the securing region and has a platform on which a blade airfoil with a profiled cross-section and with a pressure-side wall and a suction-side wall is arranged, wherein each outer face of the pressure-side wall and/or the suction-side wall transitions into the platform surface via an outer rounded section. The turbine blade also has at least one cavity which is arranged in the blade airfoil and extends into the platform region and in which at least one rib is provided that connects the pressure-side wall to the suction-side wall, the rib extending along a longitudinal direction of the blade airfoil so as to divide the cavity. At least one slot is introduced into the rib in the platform region, the rib passing through the rib and being arranged in the longitudinal direction.

### CROSS REFERENCE TO RELATED APPLICATIONS

This application is the US National Stage of International Application No. PCT/EP2014/070107 filed Sep. 22, 2014, and claims the benefit thereof. The International Application claims the benefit of European Application No. EP13189518 filed Oct. 21, 2013. All of the applications are incorporated by reference herein in their entirety.

### FIELD OF INVENTION

The invention relates to a turbine blade for a gas turbine, comprising a securing region and a platform region that adjoins the securing region and comprises a platform on which a blade airfoil with a profiled cross section and with a pressure-side wall and a suction-side wall is arranged, wherein the outer sides of the pressure-side wall and/or the suction-side wall each merge into the platform surface via an outer rounded section, and comprising at least one cavity which is arranged in the blade airfoil and extends into the platform region and in which at least one rib connecting the pressure-side wall to the suction-side wall is provided, said rib extending along a longitudinal direction of the blade airfoil, subdividing the cavity.

### BACKGROUND OF INVENTION

Turbine blades of the above-mentioned type are used in gas turbines to convert the energy of a hot gas stream into rotational energy. They typically have a blade airfoil pierced by cavities for guiding cooling air, wherein the cavities extend in the manner of channels along the longitudinal direction, i.e. from the platform as far as the blade tip, and are separated from one another by ribs. The ribs thus extend from the pressure-side wall to the suction-side wall.

Cast turbine blades frequently have a transition region between blade airfoil and platform surface, which, by means of a rounded portion like a hollow throat, thickens the pressure-side wall and the blade-side wall in this region. In the transition region there is thus an accumulation of material, which is also accompanied by a step in the stiffness of the blade airfoil. The blade airfoil is thus stiffer in the region of the platform than in regions in the direction of the blade tip. Therefore, however, the temperature gradients introduced in particular by the ribs in the region of the platform cause high thermal stresses, which limit the service life of the turbine blade and increase the outlay on maintenance.

Approaches to solutions for this hitherto consisted in reinforcing the heat-insulating coating in the region of the platform, although this increases the technical outlay for production and therefore the costs. Alternatively, it was proposed to arrange for the subdivision of the cavity by the ribs not to extend as far as the platform region, or else to provide generous openings in the ribs in this region, as proposed, for example, in WO 2009/106462 A1. However, this merely displaces the problem into other regions or makes the guidance of the cooling air within the blade poorer.

### SUMMARY OF INVENTION

It is therefore an object of the invention to specify a turbine blade of the type mentioned at the beginning which, by means of technically simple measures, exhibits a higher service life.

According to the invention, this object is achieved in that at least one slot is introduced into the rib in the platform region, passing through said rib and being arranged in the longitudinal direction.

The invention is based on the thought that, for good guidance of the cooling air, no generous interruptions or shortenings of the ribs in the platform region of the turbine blade should be provided. Nevertheless, the stiffness in this region should be reduced and the thermal gradients that occur here should be decoupled. This is possible by a slot being introduced into the rib, extending at right angles to the thermal gradient, i.e. substantially parallel to the pressure-side wall and suction-side wall. The slot permits a different thermal expansion and decouples individual regions with different thermal loading. In an advantageous refinement, a plurality of parallel slots passing through the rib and arranged in the longitudinal direction are introduced into said rib in the platform region.

In this way, the stiffness is reduced still further and the thermal decoupling is further intensified. In addition, this permits improved adaptation of the slot geometry to the tensile loadings that actually occur.

A further adaptation to the tensile loadings that occur in operation of the gas turbine results from the length of the slots advantageously decreasing between pressure-side wall and suction-side wall, starting from the center. The result is a more intense reduction in the stiffness in the center of the turbine blade.

In an additional or alternative advantageous refinement, a transverse slot passing through the rib is arranged on a long-side end of the respective slot. Such a transverse slot which, together with the main slot, forms the shape of a T, can likewise be advantageous in specific blade geometries with regard to the thermal decoupling. By means of such an arrangement, under certain circumstances it is also possible to dispense with the introduction of multiple parallel slots.

In an advantageous refinement, the respective slot passes through the end edge of the rib that faces the securing region, i.e. the slots are introduced starting from the end edge. The result is a comb-like interruption of the end edge, which produces the desired reduction in the stiffness.

Here, the end edge is advantageously arranged between the platform region and securing region. Therefore, still comparatively good subdivision of the individual cooling air channels in the platform region is possible.

A stator or rotor for a turbine advantageously comprises such a turbine blade as a guide vane or rotor blade.

A turbine advantageously comprises such a stator and/or rotor.

Advantageously, the turbine is designed as a gas turbine. It is precisely in gas turbines that the thermal and mechanical loadings are particularly high, so that the configuration of the turbine blade described offers special advantages with regard to the cooling and therefore also the efficiency.

A power plant advantageously comprises such a turbine.

The advantages achieved by using the invention consist in particular in the fact that, as a result of the introduction of slots into the channels bounding the cooling channels of a turbine blade in the platform region, a reduction in the stiffness and decoupling of the thermal gradient are achieved. Therefore, the thermal loading is reduced, so that the tensile loading in the turbine blade becomes lower overall. This increases the service life and leads to lower wear and reduced outlay on maintenance. At the same time, this measure requires comparatively little technical outlay and permits economical realization of the aforementioned advantages.

### BRIEF DESCRIPTION OF THE DRAWINGS

Exemplary embodiments of the invention will be explained in more detail by using a drawing, in which:

FIG. 1 shows a partial longitudinal section through a gas turbine,

FIG. 2 shows a profile of a rotor blade,

FIG. 3 shows a longitudinal section through the rotor blade,

FIG. 4 shows a rib with a slot with transverse slot, and

FIG. 5 shows a rib with multiple parallel slots.

### DETAILED DESCRIPTION OF INVENTION

The same parts are provided with the same designations in all the figures.

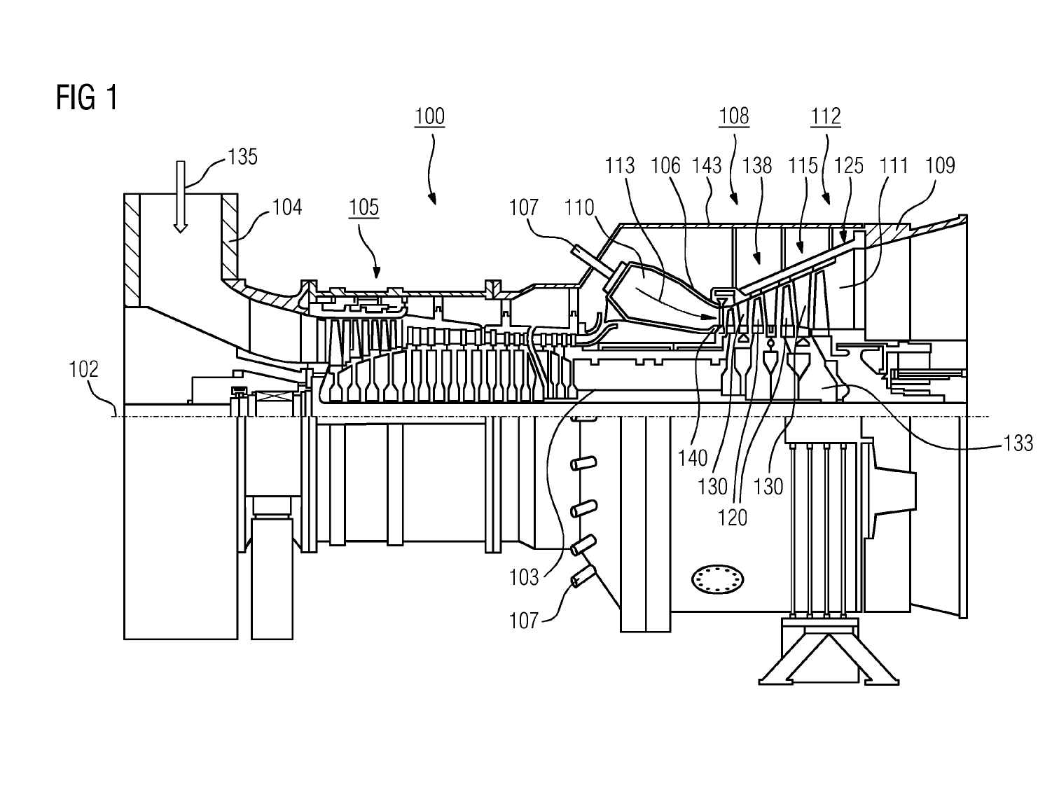

FIG. 1 shows a turbine 100, here a gas turbine, in a longitudinal partial section. A turbine 100 is a fluidic machine which converts the internal energy (enthalpy) of a flowing fluid (liquid or gas) into rotational energy and ultimately into mechanical drive energy.

The gas turbine 100 has in the interior a rotor 103 mounted such that it can rotate about an axis of rotation 102 (axial direction), which is also designated as a turbine rotor. Along the rotor 103, an intake housing 104, a compressor 105, a torus-like combustion chamber 110, in particular an annular combustion chamber 106, having multiple coaxially arranged burners 107, a turbine 108 and the exhaust gas housing 109 follow one another.

The annular combustion chamber 106 communicates with a ring-shaped hot gas channel 111. There, for example, four turbine stages 112 connected one after another form the turbine 108. Each turbine stage 112 is formed from two rings of blades. As viewed in the direction of flow of a working medium 113, a row of guide vanes 115 is followed in the hot gas channel 111 by a row 125 formed from rotor blades 120. The blades 120, 130 are profiled so as to be slightly curved, similarly to an aircraft wing.

The guide vanes 130 here are fixed to the stator 143, whereas the rotor blades 120 of a row 125 are fitted to the rotor 103 by means of a turbine disk 133. The rotor blades 120 thus form constituent parts of the rotor 103. A generator or working machine (not illustrated) is coupled to the rotor 103.

During the operation of the gas turbine 100, air 135 is sucked in by the compressor 105 through the intake housing 104 and is compressed. The compressed air provided at the turbine-side end of the compressor 105 is led to the burners 107 and mixed with a combustion agent there. The mixture is then burned in the combustion chamber 110, forming the working medium 113. From said combustion chamber, the working medium 113 flows along the hot gas channel 111 past the guide vanes 130 and the rotor blades 120.

Part of the internal energy is extracted from the fluid stream by the most eddy-free laminar flow possible around the turbine blades 120, 130, and is transferred to the rotor blades 120 of the turbine 108. Via the latter, the rotor 103 is then set rotating, as a result of which firstly the compressor 105 is driven. The usable power is output to the working machine, not illustrated.

During the operation of the gas turbine 100, the components exposed to the hot working medium 113 are subject to thermal loadings. The guide vanes 130 and rotor blades 120 of the first turbine stage 112, as seen in the direction of flow of the working medium 113, are those most thermally loaded, in addition to the heat shield blocks lining the annular combustion chamber 106. The high loadings make extremely highly durable materials necessary. The turbine blades 120, 130 are therefore fabricated from titanium alloys, nickel super-alloy or tungsten-molybdenum alloys. For higher resistance to temperatures and erosion, such as for example “pitting corrosion”, the blades are protected by coatings against corrosion (MCrAlX; M=Fe, Co, Ni, rare earths) and heat (heat insulating layer, for example ZrO2, Y2O4—ZrO2). The coating for heat shielding is called Thermal Barrier Coating or TBC for short. Further measures to make the blades more heat resistant consist in sophisticated cooling channel systems. This technique is applied both in the guide vanes and in the rotor blades 120, 130.

Each guide vane 130 has a guide vane root (not illustrated here) facing the inner housing 138 of the turbine 108 and also designated as a platform, and a guide vane head located opposite the guide vane root. The guide vane head faces the rotor 103 and is secured to a sealing ring 140 of the stator 143. Each sealing ring 140 encloses the shaft of the rotor 103. Likewise, each rotor blade has such a rotor blade root, as illustrated further in the following FIG. 3, but ends in a rotor blade tip.

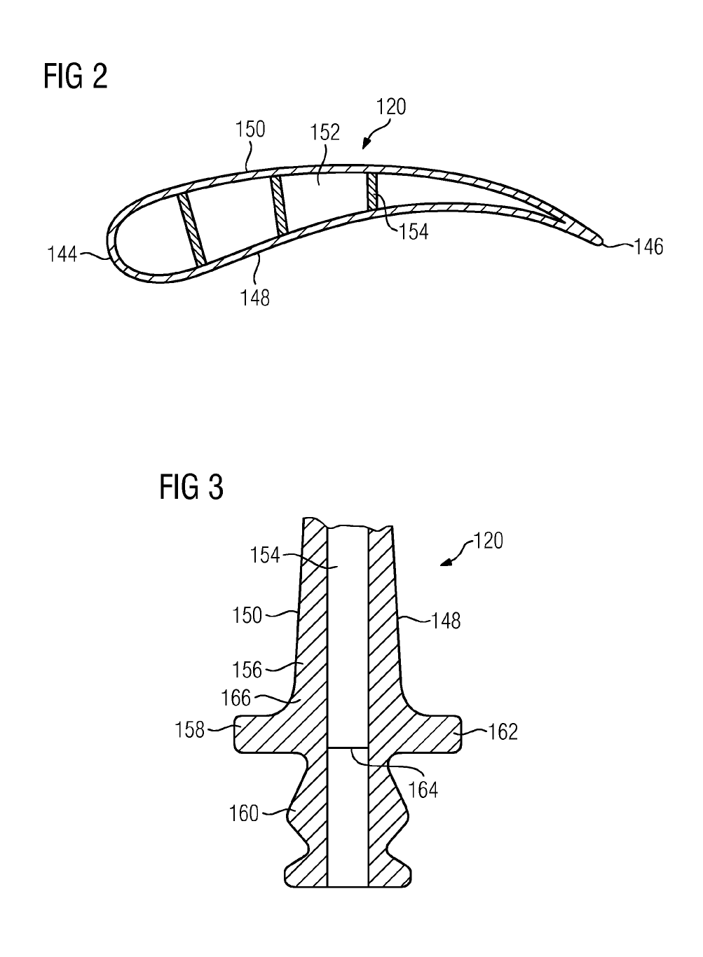

The profile of a rotor blade 120 is shown by way of example in FIG. 2. The profile resembles that of an aircraft wing. It has a rounded profile nose 144 and a rear profile edge 146. The concave pressure-side wall 148 and the convex suction-side wall 150 of the rotor blade 120 extend between the profile nose 144 and the rear profile edge 146. Cooling air channels 152 are introduced between pressure-side wall 148 and suction-side wall 150, extend along the longitudinal direction of the rotor blade 120, leading into FIG. 2, and are delimited from one another by ribs 154. In other words: the ribs 154 subdivide the cavity between pressure-side wall 148 and suction-side wall 150 into cooling air channels 152.

FIG. 3 shows the rotor blade 120 in longitudinal section from the view of the profile nose 144. The pressure-side wall 148 and the suction-side wall 150 are shown in the blade airfoil region 156. The blade region 156 is followed by the platform region 158 and the securing region 160. Arranged in the platform region is the transversely oriented platform 162 that has already been mentioned, which is used to seal off the rotor 103 against the hot gas. Fitted underneath the platform 162 in the securing region are profiled sections, by means of which the rotor blade 120 is fixed to the rotor 103 in the manner of a tongue and groove connection.

A rib 154 can be seen between pressure-side wall 148 and the suction-side wall 150. Said rib extends over the blade airfoil region 156 and ends approximately flush with the underside of the platform 162. Its end edge 164 is thus located between platform region 158 and securing region 160. Cooling air enters at the lower end of FIG. 3 and is thus guided into the cooling air channel 152 bounded by the rib 154.

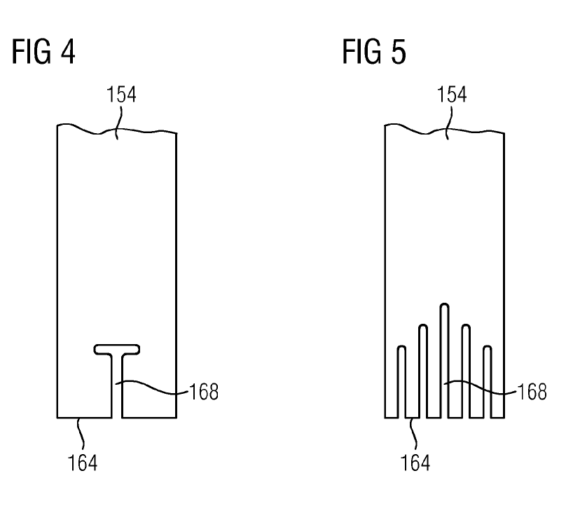

The outer sides of the pressure-side wall 148 and of the suction-side wall 150 merge via a rounded section 166 into the surface of the platform 162. As a result of the resultant high stiffness and the temperature gradient in this region, particularly high loadings of the material arise. This problem is solved by a configuration of the rib 154 according to FIGS. 4 and 5, specifically by slots 168 being introduced into the rib 154.

FIG. 4 shows a first embodiment of the rib 154 with a slot 168, which, originating centrally between pressure-side wall 148 and suction-side wall 150, extends from the end edge 164 into the rib 154. In its length, said slot extends approximately over the platform region 158. It pierces the rib 154 completely in the direction from the profile nose 144 toward the rear profile edge 146. At its inner rib end, the slot 168 merges into a short transverse slot 170, which extends parallel to the end edge 164.

FIG. 5 shows an alternative embodiment having five slots 168, which, distributed uniformly on the end edge 164, extend parallel to one another into the rib 154, starting from the end edge 164. The slots 168 likewise pierce the rib 154 completely in the direction from the profile nose 144 to the rear profile edge 146. The central slot 168 extends furthest into the rib 154, while the extension depth of the remaining slots 168 toward the pressure-side wall 148 and suction-side wall 150 decreases approximately linearly.

In principle, further arrangements of slots 168 are possible and should be chosen on the basis of the actual tensile loading of the blades 120, 130. The structure described, in particular of the rib 154 in the platform region 158, has been explained by using the example of a rotor blade 120. Just such structures with slots 168 can also be provided in a corresponding way in guide vanes 130.

1. A turbine blade for a gas turbine, comprising
a securing region and a platform region that adjoins the securing region and comprises a platform on which a blade airfoil with a profiled cross section and with a pressure-side wall and a suction-side wall is arranged,
wherein the outer sides of the pressure-side wall and/or the suction-side wall each merge into the platform surface via an outer rounded section,
at least one cavity which is arranged in the blade airfoil and extends into the platform region and in which at least one rib connecting the pressure-side wall to the suction-side wall is provided, said rib extending along a longitudinal direction of the blade airfoil, subdividing the cavity,
wherein at least one slot is introduced into the rib in the platform region, passing through said rib and being arranged in the longitudinal direction.

2. The turbine blade as claimed in claim 1, further comprising:
a plurality of parallel slots passing through the rib and arranged in the longitudinal direction which are introduced into said rib in the platform region.

3. The turbine blade as claimed in claim 2,
wherein the length of the slots decreases between pressure-side wall and suction-side wall, starting from the center.

4. The turbine blade as claimed in claim 1, further comprising:
a transverse slot passing through the rib which is arranged on a long-side end of the respective slot.

5. The turbine blade as claimed in claim 1,
wherein the rib has an end edge facing the securing region,
wherein the respective slot passes through the end edge.

6. The turbine blade as claimed in claim 1,
wherein the end edge is arranged between the platform region and securing region.

7. A stator or rotor for a turbine, comprising
a turbine blade as claimed in claim 1.

8. A turbine comprising
a stator and/or rotor as claimed in claim 7.

9. A turbine as claimed in claim 8,
wherein the turbine is designed as a gas turbine.

10. A power plant comprising
a turbine as claimed in claim 8.
